(19) United States
(12) Patent Application Publication
(10) Pub. No.: US 2011/0187255 A1
(43) Pub. Date: Aug. 4, 2011

(54) Home bar door and refrigerator having the same

(75) Inventors: Sang Chul Ryu, Gwangju (KR); Yea Jong Bong, Gwangju (KR)

(73) Assignee: Samsung Electronics Co., Ltd., Suwon-si (KR)

(21) Appl. No.: 12/929,509

(22) Filed: Jan. 28, 2011

(30) Foreign Application Priority Data
Feb. 3, 2010 (KR) 10-2010-0009781

(51) Int. Cl. F25D 23/04; E06B 3/40; E05F 5/08; E05F 3/20

(52) U.S. Cl. 312/405; 49/386; 16/85; 16/54

(57) ABSTRACT

A refrigerator including a refrigerator body, a door to open and close the front of the refrigerator body, the door having an opening, a home bar door to open and close the opening, and a hinge device provided at the home bar door, wherein the hinge device includes a hinge shaft, a damper including a case, a first rotation member rotatably disposed in the case, a second rotation member configured to be rotated together with the first rotation member, and a fluid contained in the case to apply rotational resistance to the first rotation member, and an elastic member coupled to the damper to apply force in the direction in which the door is opened, the second rotation member including a fixing part to fix the hinge shaft, a receiving part to receive the elastic member, and a coupling part coupled to the first rotation member.

### CROSS-REFERENCE TO RELATED APPLICATIONS

This application claims the benefit of Korean Patent Application No. 2010-0009781, filed on Feb. 3, 2010 in the Korean Intellectual Property Office, the disclosure of which is incorporated herein by reference.

### BACKGROUND

1. Field

Embodiments relate to a hinge device to prevent a home bar door formed at the front of a door of a refrigerator from not opening and a refrigerator having the same.

2. Description of the Related Art

Generally, a refrigerator is an appliance wherein a refrigeration cycle is formed by a compressor, a condenser, an expansion device and an evaporator, a liquid-phase refrigerant flowing in the evaporator absorbs heat from a storage chamber during evaporation of the refrigerant to store various kinds of food fresh in the storage chamber in a refrigerated state or in a frozen state for a long time.

In recent years, demand for large and luxury refrigerators has gradually increased according to improvement of living environment. As a result, refrigerators with increased capacity storage chambers have been increasingly popular.

However, refrigerators with increased capacity storage chambers consume increased power. In recent years, therefore, refrigerators have been developed and placed on sale each of which include a home bar, having a simple storage chamber, mounted in a door at one side of a storage chamber so that the home bar door is opened without opening the door to conveniently take out simple kinds of food, such as beverages, thereby reducing power consumption and improving user convenience.

A home bar door to open and close an opening formed by removing a predetermined portion of the door so that the interior of the refrigerator communicates with the outside via the opening is mounted at the home bar. Generally, the home bar door has a latch device and a hinge device to open and close the opening formed at the door.

The home bar door is kept closed by a latch catcher of the latch device. When a user pushes the home bar door, the home bar door is unlocked from the latch catcher and opens 90 degrees due to gravity.

However, if the home bar door is not used for a long time or foreign matter, such as leftovers of food, is collected between the opening of the door and the home bar door, the home bar door may not open although the home bar door is unlocked from the latch catcher or may not open to the extent that the home bar door freely falls with the result that a user may need to forcibly open the home bar door.

### SUMMARY

It is an aspect to provide a refrigerator having a hinge device that enables the initial opening of a home bar door of the refrigerator to be smoothly performed.

It is another aspect to provide a refrigerator having a hinge device that eliminates the need for a user to forcibly open a home bar door, thereby improving user convenience.

Additional aspects will be set forth in part in the description which follows and, in part, will be apparent from the description, or may be learned by practice of the invention.

In accordance with one aspect, a refrigerator includes a refrigerator body, a door to open and close a front of the refrigerator body, the door having an opening, a home bar door to open and close the opening, and a hinge device provided at the home bar door, wherein the refrigerator further includes a gasket provided at the edge of the opening, a latch device mounted above the edge of the opening, and a detection device mounted at one side of the edge of the opening to detect opening and closing of the home bar door, and the hinge device includes a hinge shaft, a damper including a case, a first rotation member rotatably disposed in the case, a second rotation member configured to be rotated together with the first rotation member, and a fluid contained in the case to apply rotational resistance to the first rotation member, and an elastic member coupled to the damper to apply force in the direction in which the door is opened, the second rotation member including a fixing part to fix the hinge shaft, a receiving part to receive the elastic member, and a coupling part coupled to the first rotation member.

The elastic member may include a torsion spring to surround the receiving part, the torsion spring having one end fixed to the case and the other end fixed to the fixing part.

The fixing part may have a slot in which the other end of the torsion spring is located.

The slot may be provided at a position of the fixing part where twisting force is applied to the torsion spring in the direction in which the home bar door is opened in a closed state of the home bar door.

The first rotation member and the second rotation member may be integrally formed.

In accordance with another aspect, a home bar door to open and close an opening formed at the front of the refrigerator body includes a hinge device to open and close the home bar door, wherein the hinge device includes a damper including a hinge shaft and an elastic member coupled to the damper to apply force to the home bar door in the direction in which the home bar door is opened.

The damper may include a case, a first rotation member rotatably disposed in the case, a second rotation member configured to be rotated together with the first rotation member, and a fluid contained in the case to apply rotational resistance to the first rotation member.

The second rotation member may include a fixing part to fix the hinge shaft, a receiving part to receive the elastic member, and a coupling part coupled to the first rotation member.

The elastic member may include a torsion spring to surround the receiving part, the torsion spring having one end fixed to the case and the other end fixed to the fixing part.

The fixing part may have a slot in which the other end of the torsion spring is located.

The slot may be provided at a position of the fixing part where twisting force is applied to the torsion spring in the direction in which the home bar door is opened in a closed state of the home bar door.

The first rotation member and the second rotation member may be integrally formed.

In accordance with a further aspect, a hinge device of a home bar door to open and close an opening formed at the front of a refrigerator body includes a hinge shaft, a damper including a case, a rotation member rotatably disposed in the case, and a fluid contained in the case to apply rotational resistance to the rotation member, and an elastic member coupled to the damper to apply force in the direction in which the door is opened, wherein the elastic member applies elastic force in the direction opposite to the rotation member.

The rotation member may include a first rotation member and a second rotation member configured to be rotated together with the first rotation member, and the first rotation member may include a rotational shaft, a flange formed at the outer circumference of the rotational shaft, and a blade protruding from the outer circumference of the rotational shaft in the radial direction.

The second rotation member may include a fixing part to fix the hinge shaft, a receiving part to receive the elastic member, and a coupling part coupled to the first rotation member.

The fixing part may have a slot in which an end of the elastic member is located.

The slot may be provided at a position of the fixing part where twisting force is applied to the elastic member in the direction in which the home bar door is opened in a closed state of the home bar door.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating the external appearance of a refrigerator having a home bar door according to an embodiment;

FIG. 2 is a perspective view of the home bar door shown in FIG. 1, separated from a storage chamber door;

FIG. 3 is a perspective view illustrating the coupling structure of the home bar door and a hinge device according to an embodiment;

FIG. 4 is a perspective view of the hinge device;

FIG. 5 is an exploded perspective view of the hinge device;

FIG. 6 is a sectional view of the hinge device; and

FIG. 7 is a view illustrating the operating principle of the hinge device.

### DETAILED DESCRIPTION

Reference will now be made in detail to the embodiments, examples of which are illustrated in the accompanying drawings, wherein like reference numerals refer to like elements throughout.

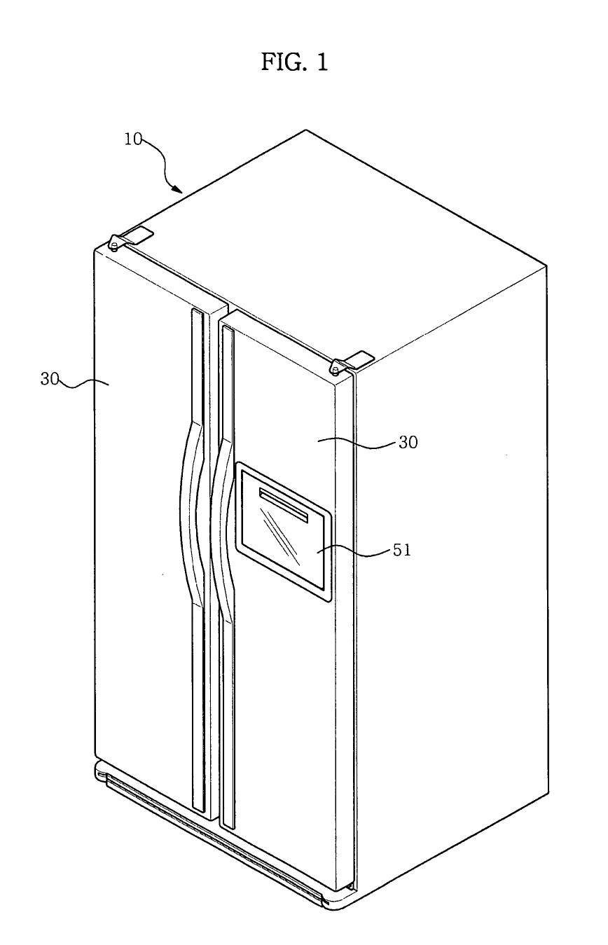

FIG. 1 is a perspective view illustrating the external appearance of a refrigerator having a home bar door according to an embodiment.

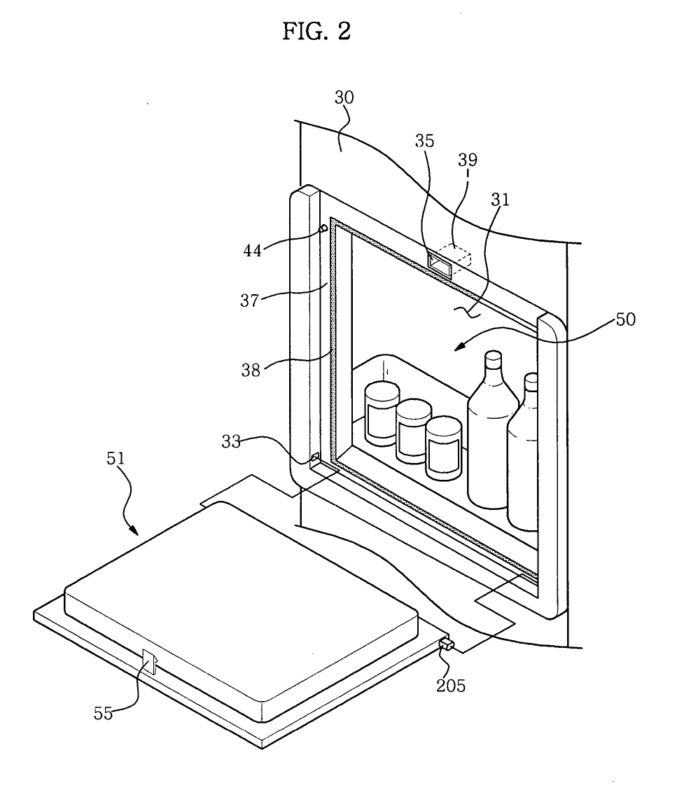

As shown in FIG. 1, the refrigerator includes a refrigerator body 10 open at the front thereof, the refrigerator body 10 having a storage chamber defined therein, a storage chamber door 30 mounted at the open front of the refrigerator body 10 to open and close a storage chamber constituting a freezing chamber or a refrigerating chamber, a home bar 50 (see FIG. 2) provided at the storage chamber door 30, the home bar 50 having a storage space, and a home bar door 51 mounted at the front of the home bar 50 to open and close the home bar 50.

In the above-described structure, beverages or alcoholic drinks may be put into or taken out of the home bar 50 through the home bar door 51, which is smaller than the storage chamber door 30, without opening the storage chamber door 30.

FIG. 2 is a perspective view of the home bar door shown in FIG. 1, separated from the storage chamber door.

As shown in FIG. 2, an opening 31 is formed at the front of the storage chamber door 30 so that a user accesses the home bar 50 from the outside of the storage chamber door 30 through the opening 31.

A gasket 38 is provided at an edge 37 of the opening 31. The gasket 38 is disposed at the rear of the home bar door 51 to prevent cool air from being discharged out of the home bar 50.

Also, a detection device 44 to detect opening or closing of the home bar door 51 is provided at the edge 37 of the opening 31. A contact switch or a magnet may be used as the detection device 44.

The size of the home bar door 51 corresponds to that of the opening 31. Hinge shafts 205, which are fitted in hinge holes 33 provided at the left-side and right-side lower ends of the opening 31, are coupled to the lower part of the home bar door 51. Generally, the hinge shafts 205 protrude from opposite sides of the home bar door 51 in the shape of a rod.

A hook member 55 is mounted at the inside upper end of the home bar door 51. The hook member 55 is locked into a latch device 39 mounted in a hook hole 35 formed above the opening 31 so that the home bar door 51 closes the opening 31. Also, the hook member 55 is unlocked from the latch device 39 so that the home bar door 51 opens the opening 31.

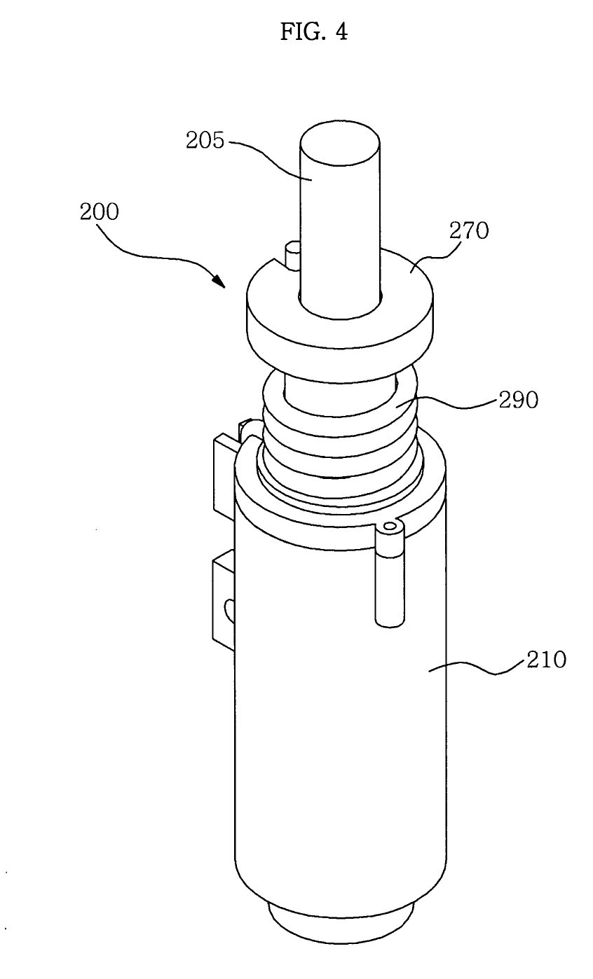

A hinge device 200 (see FIG. 4) to smoothly open the home bar door 51 is mounted at the right-side lower end of the home bar door 51.

In the above-described structure, the home bar door 51 may be locked into or unlocked from the opening 31 of the storage chamber door 30 by the hook member 55 and the latch device 39. When the home bar door 51 is unlocked from the opening 31 of the storage chamber door and rotates about the hinge shafts 205, the home bar door 51 is smoothly opened by the hinge device 200 mounted at the home bar door 51.

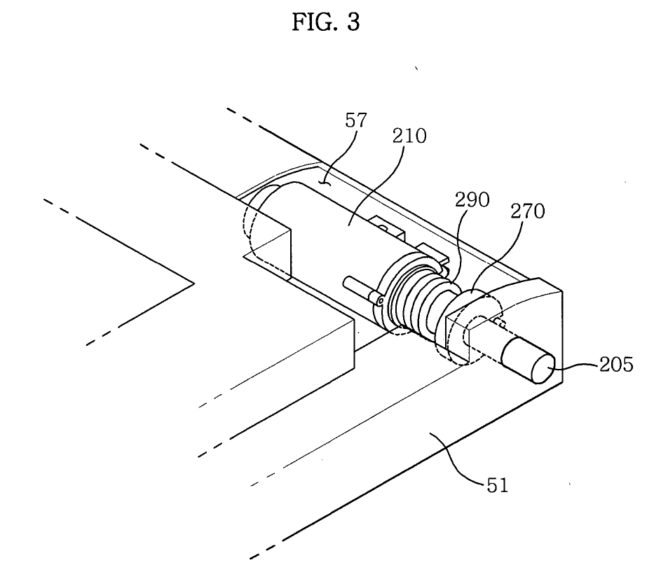

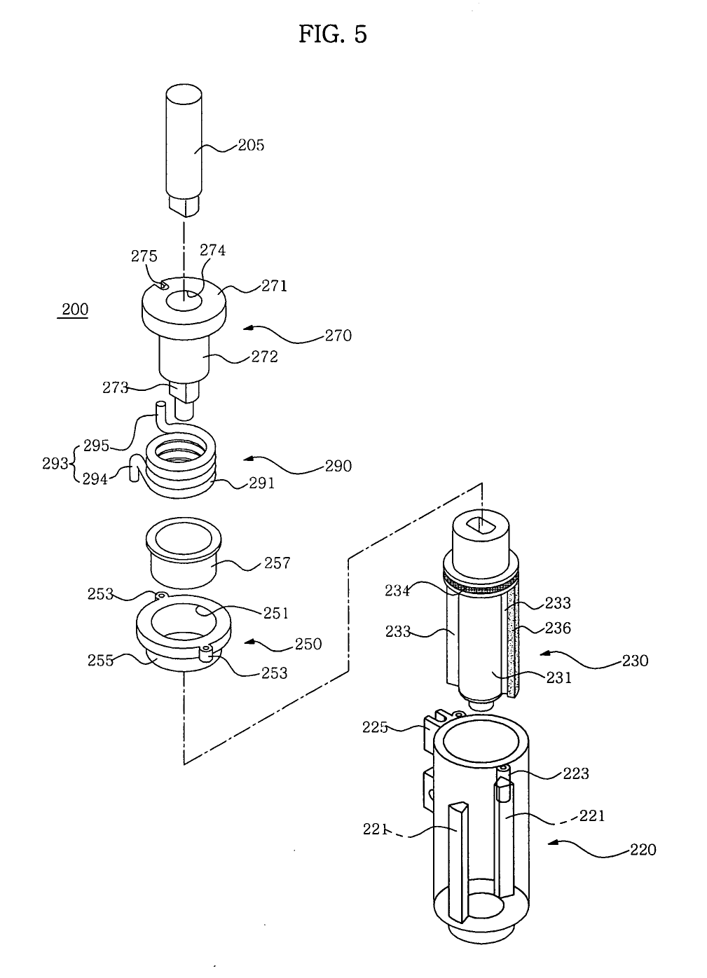

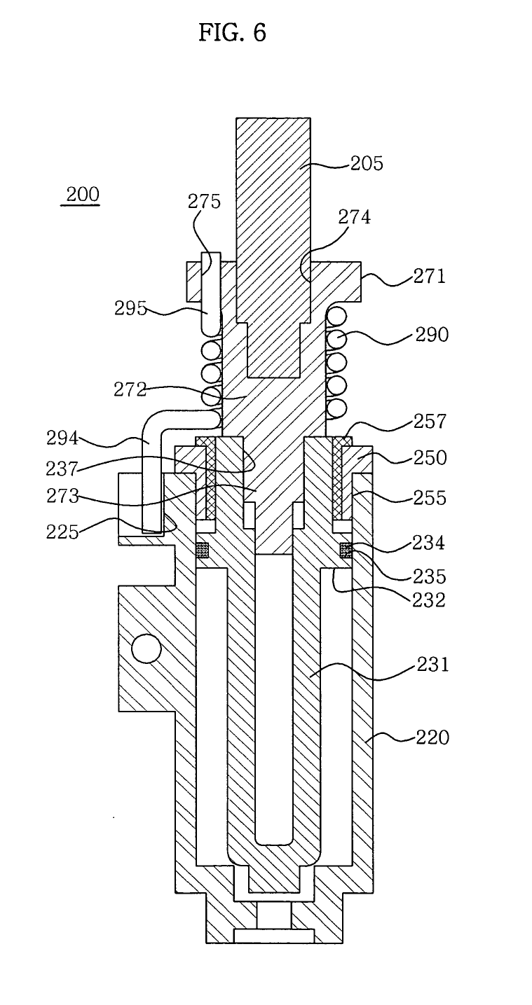

FIG. 3 is a perspective view illustrating the coupling structure of the home bar door and the hinge device, FIG. 4 is a perspective view of the hinge device, FIG. 5 is an exploded perspective view of the hinge device, and FIG. 6 is a sectional view of the hinge device.

As shown in FIG. 3, the hinge device 200 is fixedly fitted in an installation hole 57 formed at the lower end of the home bar door 51. After the insertion of the hinge device 200, the hinge device 200 is fixed by a coupling member (not shown) in a state in which the top of the installation hole 57 is covered by a cover (not shown).

As shown in FIGS. 4 to 6, the hinge device 200 includes a damper 210 including a case 220, a first rotation member 230 rotatably disposed in the case 220, a case cover 250 to cover the top of the case 220, and a fluid contained in the case 220 to apply rotational resistance to the first rotation member 230.

The case 220 is formed in the shape of a cylinder open at the top thereof. A pair of opposite barriers 221 is provided at the inner wall of the case 220. Also, the case 220 is provided at the outer circumference thereof with a coupling part 223 coupled to the case cover 250 and an elastic member fixing part 225 to fix one end of an elastic member 290.

The first rotation member 230 includes a cylindrical rotational shaft 231, a circular flange 232 formed at the outer circumference of the rotational shaft 231, and a pair of blades 233 protruding from the outer circumference of the rotational shaft 231 below the flange 232 in the radial direction.

The flange 232 is provided with a sealing groove 235, in which an O-ring 234 to prevent leakage of the fluid from the case 220. Each of the blades 233 may be provided with an elastic wing 236 to compress the fluid in the case 220 in the rotation direction of the first rotation member 230 when the first rotation member 230 is rotated only in one direction.

At the case cover 250 is formed a through hole 251, through which the rotational shaft 231 of the first rotation member 230 above the flange 232 extends. He case cover 250 is provided at the outer circumference thereof with coupling parts 253, through which the case cover 250 is threadedly coupled to the case 220. Also, a cylindrical step 255, which is inserted into the case 220, is provided at the bottom of the case cover 250.

A bush 257 to prevent damage to the first rotation member 230 and the case cover 250 due to friction is provided between the case cover 250 and the rotational shaft 231.

Also, the hinge device 200 further includes a second rotation member 270 coupled to the first rotation member 230 so as to be rotated with the first rotation member 230, an elastic member 290 to apply force to the second rotation member 270 in the direction opposite to the rotation direction of the second rotation member 270 when the second rotation member 270 is rotated in one direction, and a hinge shaft 205.

The second rotation member 270 includes a fixing part 271 to which the hinge shaft 205 is coupled, a receiving part 272 to receive the elastic member 290, and a coupling part 273 coupled to the first rotation member 230.

A hinge hole 274, in which the hinge shaft 205 is coupled, is formed at the center of the fixing part 271. The fixing part 271 is provided at the outer circumference thereof with a slot 275, in which a second lever 295 of the elastic member 290 is coupled.

The coupling part 273 is formed in a polygonal shape in section, by which the second rotation member 270 is rotated simultaneously with the first rotation member 230. The coupling part 273 is fitted in a coupling hole 237 provided at the first rotation member 230.

In this embodiment, the first rotation member 230 and the second rotation member 270 are separately provided so that the first rotation member 230 and the second rotation member 270 are coupled to each other. Alternatively, the first rotation member 230 and the second rotation member 270 may be integrally formed.

A torsion spring including a circular spring body 291 and a pair of levers 293 formed at opposite ends of the spring body 291 may be used as the elastic member 290. However, the elastic member 290 is not limited to the torsion spring. Anything may be used as the elastic member 290 as long as it applies force to the second rotation member 270 in the direction opposite to the rotation direction of the second rotation member 270. For example, a spiral spring, which is formed by winding a thin and long strip in a spiral shape.

The spring body 291 is provided to surround the receiving part 272 of the second rotation member 270. The levers 293 include a first lever 294 fixed to the elastic member fixing part 225 provided at the case 220 and a second lever 295 fixed in the slot 275 formed at the fixing part 271 of the second rotation member 270.

Hereinafter, the operation of the hinge device 200 will be described.

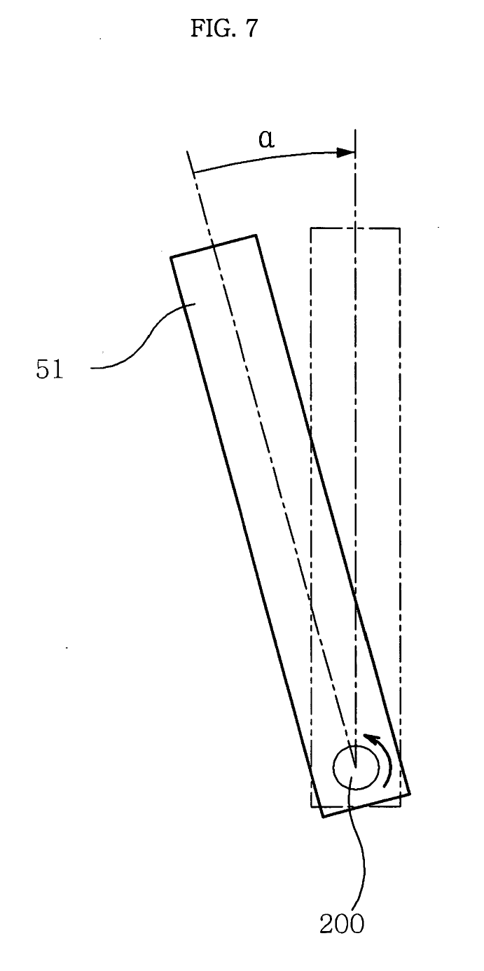

FIG. 7 is a view illustrating the operating principle of the hinge device.

As shown in FIGS. 3 and 7, the hinge device 200 is disposed at the lower end of the home bar door 51.

In a closed state of the home bar door 51, the hook member 55 mounted at the inside upper end of the home bar door 51 is latched into the latch device 39 mounted in the hook hole 35 formed above the opening 31 with the result that the home bar door 51 is locked into the opening 31 of the storage chamber door 30.

At this time, the elastic member 290 of the hinge device 200 applies elastic force to the home bar door 51 in the direction in which the home bar door 51 is opened.

The first lever 294 of the elastic member 290 is fixed to the elastic member fixing part 225, and the second lever 295 of the elastic member 290 is fixed in the slot 275 formed at the fixing part 271. Consequently, the position of the slot 275 or the initial rotation angle of the second rotation member 270 may be changed to change the rotation angle of the second lever 295 fixed in the slot 275.

The first lever 294 of the elastic member 290 is fixed to the elastic member fixing part 225 provided at the case 220. When the rotation angle of the second lever 295 is changed in a state in which elastic force is not generated from the elastic member 290, therefore, elastic force is generated in the direction opposite to the rotation direction of the second lever 295.

The magnitude and operation direction of the elastic force from the elastic member 200 coupled to the hinge device 200 may be set as described above so that the elastic force is applied in the direction in which the locked home bar door 51 is opened (in the direction indicated in FIG. 7) and at an initial open angle α.

When a user applies pressure to the upper part of the home bar door 51 so as to open the home bar door 51, the opening operation of the home bar door 51 is initiated by the elastic operation of the latch device 39, and the hook member 55 of the home bar door 51 is separated from a latch catcher (not shown) of the latch device 39.

At this time, the elastic member 290 applies elastic force to the home bar door 51 in the direction in which the home bar door 51 is opened. Consequently, the home bar door 51 is opened at the initial open angle a by the elastic force of the elastic member 290 the moment the hook member 55 is separated from the latch catcher (not shown) of the latch device 39.

Even when the home bar door 51 is not used for a long time or foreign matter, such as leftovers of food, is collected between the opening 31 of the storage chamber door 30 and the home bar door 51, therefore, the home bar door 51 may be easily separated from the opening 31 of the storage chamber door 30 by the elastic force of the elastic member 90 coupled to the hinge device 200.

After being opened by the initial open angle a, the home bar door 51 opens at a proper opening speed. This is because the damper 210 prevents the home bar door 51 from abruptly opening. That is, the initial opening of the home bar door 51 is initiated by the elastic member 290, and then the home bar door 51 opens at the proper opening speed by cooperation between the elastic force of the elastic member 290 and the operation of the damper 210 to apply resistance to the home bar door 51 in the direction opposite to the opening direction of the home bar door 51.

As is apparent from the above description, the initial opening of the home bar door of the refrigerator is smoothly performed.

Also, it may not be necessary for a user to forcibly open the home bar door, thereby improving user convenience.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
a refrigerator body, a door to open and close a front of the refrigerator body, the door having an opening, a home bar door to open and close the opening, and a hinge device provided at the home bar door, wherein the refrigerator further comprises a gasket provided at an edge of the opening, a latch device mounted above the edge of the opening, and a detection device mounted at one side of the edge of the opening to detect opening and closing of the home bar door, and the hinge device comprises
a hinge shaft;
a damper comprising a case, a first rotation member rotatably disposed in the case, a second rotation member configured to be rotated together with the first rotation member, and a fluid contained in the case to apply rotational resistance to the first rotation member; and
an elastic member coupled to the damper to apply force in a direction in which the door is opened,
the second rotation member comprising a fixing part to fix the hinge shaft, a receiving part to receive the elastic member, and a coupling part coupled to the first rotation member.

2. The refrigerator according to claim 1, wherein the elastic member comprises a torsion spring to surround the receiving part, the torsion spring having one end fixed to the case and the other end fixed to the fixing part.

3. The refrigerator according to claim 2, wherein the fixing part has a slot in which the other end of the torsion spring is located.

4. The refrigerator according to claim 3, wherein the slot is provided at a position of the fixing part where twisting force is applied to the torsion spring in a direction in which the home bar door is opened in a closed state of the home bar door.

5. The refrigerator according to claim 4, wherein the first rotation member and the second rotation member are integrally formed.

6. A home bar door to open and close an opening formed at a front of the refrigerator body, comprising:
a hinge device to open and close the home bar door,
wherein the hinge device comprises
a damper comprising a hinge shaft; and
an elastic member coupled to the damper to apply force to the home bar door in a direction in which the home bar door is opened.

7. The home bar door according to claim 6, wherein the damper comprises:
a case;
a first rotation member rotatably disposed in the case;
a second rotation member configured to be rotated together with the first rotation member; and
a fluid contained in the case to apply rotational resistance to the first rotation member.

8. The home bar door according to claim 7, wherein the second rotation member comprises:
a fixing part to fix the hinge shaft;
a receiving part to receive the elastic member; and
a coupling part coupled to the first rotation member.

9. The home bar door according to claim 8, wherein the elastic member comprises a torsion spring to surround the receiving part, the torsion spring having one end fixed to the case and the other end fixed to the fixing part.

10. The home bar door according to claim 9, wherein the fixing part has a slot in which the other end of the torsion spring is located.

11. The home bar door according to claim 10, wherein the slot is provided at a position of the fixing part where twisting force is applied to the torsion spring in a direction in which the home bar door is opened in a closed state of the home bar door.

12. The home bar door according to claim 11, wherein the first rotation member and the second rotation member are integrally formed.

13. A hinge device of a home bar door to open and close an opening formed at a front of a refrigerator body, comprising:
a hinge shaft;
a damper comprising a case, a rotation member rotatably disposed in the case, and a fluid contained in the case to apply rotational resistance to the rotation member; and
an elastic member coupled to the damper to apply force in a direction in which the door is opened,
wherein the elastic member applies elastic force in a direction opposite to the rotation member.

14. The hinge device according to claim 13, wherein
the rotation member comprises a first rotation member and a second rotation member configured to be rotated together with the first rotation member, and
the first rotation member comprises a rotational shaft, a flange formed at an outer circumference of the rotational shaft, and a blade protruding from the outer circumference of the rotational shaft in a radial direction.

15. The hinge device according to claim 14, wherein the second rotation member comprises a fixing part to fix the hinge shaft, a receiving part to receive the elastic member, and a coupling part coupled to the first rotation member.

16. The hinge device according to claim 15, wherein the fixing part has a slot in which an end of the elastic member is located.

17. The hinge device according to claim 16, wherein the slot is provided at a position of the fixing part where twisting force is applied to the elastic member in a direction in which the home bar door is opened in a closed state of the home bar door.

18. The hinge device according to claim 13, wherein the elastic member comprises a torsion spring including a circular spring body and a pair of levers formed at opposite ends of the spring body.

19. The hinge device according to claim 13, wherein the elastic member comprises a spiral spring.
